(19) United States
(12) Patent Application Publication
(10) Pub. No.: US 2022/0016934 A1
(43) Pub. Date: Jan. 20, 2022

(54) Tire For a Civil Engineering Vehicle, Comprising a Level-Wound Crown Reinforcement with Metal Reinforcements

(71) Applicant: COMPAGNIE GENERALE DES ETABLISSEMENTS MICHELIN, Clermont-Ferrand (FR)

(72) Inventor: François BARBARIN, Clermont-Ferrand Cedex 9 (FR)

(21) Appl. No.: 17/299,642

(22) PCT Filed: Dec. 2, 2019
(86) PCT No.: PCT/FR2019/052876

§ 371 Date: Jun. 3, 2021

(30) Foreign Application Priority Data
Dec. 5, 2018 (FR) 1872337
Feb. 4, 2019 (FR) 1901036

(51) Int. Cl. B60C 9/26

(52) U.S. Cl. CPC B60C 9/263; B60C 2200/065

(57) ABSTRACT

Reinforcers of crown layers (211, 212) of a civil engineering vehicle are made of metal and wound, in the form of a strip (5) of width W, along a circumferential zigzag trajectory following a periodic curve (7), extending over a number N of periods P distributed over a number T of circumferences 2ΠR and satisfying the two relations N*(W/sin A)=2ΠR*t, where 0.6⇐t⇐1, and N*P=2ΠR*T, so as to form a bilayer (21). Additionally, for at least 40% of the strip crossovers (53) axially positioned, relative to the circumferential direction (XX′), at an axial distance L1 equal to not more than 0.25 times the amplitude L of the periodic curve (7), the circular bilayer portion (213), centred on the strip crossover (53) and having a radius R1 equal to twice the width W of a strip (5), comprises Ne outer strip crossovers and Ni inner strip crossovers, such that |Ne-Ni|/(Ne+Ni)⇐0.3.

The subject matter of the present invention is a tire, intended to be fitted to a civil engineering vehicle, and more specifically the present invention relates to its crown reinforcement.

Typically, a tire for a civil engineering vehicle, within the meaning of the European Tire and Rim Technical Organization or ETRTO standard, is intended to be mounted on a rim with a diameter measuring at least 25 inches and possibly as much as 63 inches.

Since a tire has a geometry exhibiting symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to” and “further away from the axis of rotation of the tire”, respectively. “Axially inner/axially on the inside” and “axially outer/axially on the outside” mean “closer to” and “further away from the equatorial plane of the tire”, respectively, with the equatorial plane of the tire being the plane that passes through the middle of the tread surface and is perpendicular to the axis of rotation.

Generally, a tire comprises a tread intended to come into contact with the ground via a tread surface, the two axial ends of which are connected via two sidewalls to two beads that provide the mechanical connection between the tire and the rim on which it is intended to be mounted.

A tire also comprises a reinforcement made up of a crown reinforcement radially on the inside of the tread, and a carcass reinforcement radially on the inside of the crown reinforcement.

The carcass reinforcement of a tire for a civil engineering vehicle of construction plant type usually comprises at least one carcass layer comprising generally metal reinforcers that are coated in a polymeric material of the elastomer or elastomeric type that is obtained by blending and is known as a coating compound. A carcass layer comprises a main part that joins the two beads together and is generally wound, in each bead, from the inside of the tire to the outside, around a usually metal circumferential reinforcing element known as a bead wire so as to form a turn-up. For a radial tire, the metal reinforcers of a carcass layer are substantially mutually parallel and form an angle of between 85° and 95° with the circumferential direction.

The crown reinforcement of a radial tire for a civil engineering vehicle comprises a superposition of circumferentially extending crown layers, radially on the outside of the carcass reinforcement. Each crown layer is made up of generally metal reinforcers that are mutually parallel and are coated in a polymeric material of the elastomer or elastomeric coating compound type.

As regards the metal reinforcers, a metal reinforcer is mechanically characterized by a curve representing the tensile force (in N) applied to the metal reinforcer as a function of the relative elongation (in %) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ISO 6892 of 1984.

The total elongation at break At of the metal reinforcer is, by definition, the sum of the respectively structural, elastic and plastic elongations thereof (At=As+Ae+Ap). The structural elongation As results from the relative positioning of the metal threads making up the metal reinforcer under a low tensile force. The elastic elongation Ae results from the intrinsic elasticity of the metal of the metal threads making up the metal reinforcer, taken individually, the behaviour of the metal following Hooke's law. The plastic elongation Ap results from the plasticity, that is to say the irreversible deformation beyond the yield point, of the metal of these metal threads taken individually. These various elongations and the respective meanings thereof, which are well known to a person skilled in the art, are described, for example, in the documents U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the tensile elastic modulus or Young's modulus.

Among the metal reinforcers, a distinction is usually made between the elastic metal reinforcers and the inextensible or non-extensible metal reinforcers. In the following text, the characteristics relating to metal reinforcers are determined in metal reinforcers coated in a vulcanized elastomeric compound. An elastic metal reinforcer is characterized by a structural elongation As at least equal to 0.5%. Moreover, an elastic metal reinforcer has a tensile elastic modulus at most equal to 150 GPa, and usually between 40 GPa and 150 GPa. An inextensible metal reinforcer is characterized by a total elongation At, under a tensile force equal to 10% of the force at break Fm, at most equal to 0.2%. Moreover, an inextensible metal reinforcer has a tensile elastic modulus usually between 150 GPa and 200 GPa.

As regards the crown layers of the crown reinforcement, a distinction is usually made between the protection layers, which make up the protective reinforcement and are radially outermost, and the working layers, which make up the working reinforcement and are radially comprised between the protective reinforcement and the carcass reinforcement.

The protective reinforcement, which comprises at least one protective layer, essentially protects the working layers from mechanical or physicochemical attacks, which are likely to spread through the tread radially towards the inside of the tire.

The protective reinforcement often comprises two protection layers, which are radially superposed, formed of elastic metal reinforcers, are mutually parallel in each layer and are crossed from one layer to the next, forming angles at least equal to 10° with the circumferential direction.

The working reinforcement, comprising at least two working layers, has the function of belting the tire and conferring stiffness and road holding thereon. It absorbs both mechanical inflation stresses, which are generated by the tire inflation pressure and transmitted by the carcass reinforcement, and mechanical stresses caused by running, which are generated as the tire runs over the ground and are transmitted by the tread. It is also intended to withstand oxidation and impacts and puncturing, by virtue of its intrinsic design and that of the protective reinforcement.

The working reinforcement usually comprises two working layers, which are radially superposed, are formed of inextensible metal reinforcers, are mutually parallel within each layer and are crossed from one layer to the next, forming angles at most equal to 60°, and preferably at least equal to 15° and at most equal to 45°, with the circumferential direction.

Moreover, in order to reduce the mechanical inflation stresses that are transmitted to the working reinforcement, it is known to dispose a hoop reinforcement, having a high circumferential tensile stiffness, radially on the outside of the carcass reinforcement. The hoop reinforcement, the function of which is to at least partially absorb the mechanical inflation stresses, also improves the endurance of the crown reinforcement by stiffening the crown reinforcement, when the tire is compressed under a radial load and, in particular, subjected to a cornering angle about the radial direction.

The hoop reinforcement usually comprises two radially superposed hooping layers formed of metal reinforcers that are mutually parallel within each layer and are crossed from one layer to the next, forming angles at most equal to 10° with the circumferential direction. The hoop reinforcement can be positioned radially on the inside of the working reinforcement, between the two working layers of the working reinforcement, or radially on the outside of the working reinforcement.

Among the hooping layers, a distinction is made between the hooping layers known as closed-angle hooping layers, that is to say in which the metal reinforcers form angles at least equal to 5° and at most equal to 10° with the circumferential direction, and the circumferential, more specifically substantially circumferential, hooping layers, that is to say in which the metal reinforcers form angles at most equal to 5°, and possibly zero, with the circumferential direction. The closed-angle hooping layers comprise metal reinforcers having free ends at the axial ends of the hooping layers. The circumferential hooping layers comprise metal reinforcers that do not have free ends at the axial ends of the hooping layers, since the circumferential hooping layers are usually obtained by circumferentially winding a ply of metal reinforcers or by circumferentially winding a continuous metal reinforcer.

Therefore a frequently used crown reinforcement of a tire for a civil engineering vehicle commonly comprises six crown layers, divided into two protection layers, two working layers and two hooping layers. The complexity of this crown reinforcement arises from the need to reach, in particular, a compromise between the capacity to carry heavy loads and the capacity to run on rough terrain. At the same time, there is a need to simplify the architecture of the tire in order to reduce its manufacturing cost.

It is known, in another field of tires, namely that of aircraft tires, also intended to carry heavy loads, but for high-pressure running and at a much higher speed, on smooth terrain, to use what is known as a level-wound crown reinforcement, or more precisely a level-wound working reinforcement. Thus the documents WO 2015059172, WO 2015063131, WO 2015071152, WO 2015124758 and WO2015150133 describe a crown reinforcement comprising at least a crown bilayer made up at least partially of two radially superimposed crown layers, each made up of reinforcers coated in an elastomeric material. Each crown bilayer is made up of a circumferential zigzag winding of a strip of width W, in a circumferential direction of the tire and on a substantially cylindrical surface of revolution positioned at a radial distance R from the axis of rotation of the tire. The trajectory of the circumferential zigzag winding is a periodic curve having a period P and an amplitude L. The periodic curve forms, with the circumferential direction, an angle A measured at the points on the curve positioned in an equatorial plane passing through the centre of the tread and perpendicular to the axis of rotation. The periodic curve extends through a number N of periods P distributed over a number T of circumferences 2ΠR. Such a crown reinforcement has the advantage of limiting the number of individual crown layers and of simplifying manufacture.

However, this level-wound crown reinforcement, for an aircraft tire, is made up of crown layers comprising textile reinforcers, preferably of the aliphatic polyamide type, such as nylon, or of the aromatic polyamide type, such as aramid, or any combination of the aforementioned types. On the other hand, in the field of civil engineering, in view of the particularly severe conditions of use, it is difficult to consider the use of textile reinforcers, and it is commonly accepted that the use of metal reinforcers is a preferable solution.

Inventors have therefore set themselves the objective of proposing a tire for a civil engineering vehicle, comprising a crown reinforcement with metal reinforcers that are at least partially level-wound, compatible with use under high loads, at moderate pressures and speed, and on rough terrain.

This objective has been achieved, according to the invention, by a tire for a civil engineering vehicle, comprising:
a crown reinforcement, radially on the inside of a tread and radially on the outside of a carcass reinforcement,
the crown reinforcement comprising at least a crown bilayer made up at least partially of two radially superimposed crown layers, each made up of reinforcers coated in an elastomeric material,
each crown bilayer being made up of a circumferential zigzag winding of a strip of width W, in a circumferential direction of the tire and on a substantially cylindrical surface of revolution positioned at a radial distance R from the axis of rotation of the tire,
the trajectory of the circumferential zigzag winding being a periodic curve having a period P and an amplitude L,
the periodic curve forming, with the circumferential direction, an angle A measured at the points on the curve positioned in an equatorial plane passing through the centre of the tread and perpendicular to the axis of rotation,
the periodic curve extending through a number N of periods P distributed over a number T of circumferences 2ΠR,
the trajectory of the circumferential zigzag winding generating strip crossovers between a radially outer portion of strip and a radially inner portion of strip,
a strip crossover being outer when the radially outer portion of strip forms a positive angle B with the circumferential direction in an axial plane,
a strip crossover being inner when the radially outer portion of strip forms a negative angle B with the circumferential direction in an axial plane,
the crown layer reinforcers being made of metal,
the periodic curve of the trajectory of the circumferential zigzag winding satisfying the following relations:

N*(W/sin A)=2ΠR*t, where 0.6⇐t⇐1,

N*P=2ΠR*T,
and, for at least 40% of the strip crossovers (53) axially positioned, relative to the circumferential direction (XX′), at an axial distance L1 equal to not more than 0.25 times the amplitude L of the periodic curve (7), the circular bilayer portion (213) centred on the strip crossover (53) and having a radius equal to twice the width W of a strip (5) comprises Ne outer strip crossovers and Ni inner strip crossovers, such that |Ne-Ni|/(Ne+Ni)⇐0.3.

The principle of the invention is that of using, for at least some of the crown layers, level-wound structure comprising at least one bilayer, and, more precisely, replacing at least two crown layers with one crown bilayer, produced by the circumferential zigzag winding of a strip in a circumferential direction of the tire and on to a surface of revolution.

This crown bilayer has, in the first place, the distinctive characteristic of being produced by the level winding of a strip comprising metal reinforcers, even though the level winding method is normally used for textile reinforcers that are much easier to level wind because of their greater deformability.

The periodic curve of the trajectory of the circumferential zigzag winding must also satisfy two particular relations, defined between the parameters of said trajectory, as specified below.

As regards the first relation, each of the two crown layers making up the crown bilayer is formed by the juxtaposition of N portions of strip, the strip having a width W and forming an angle A with the circumferential direction of the tire in an equatorial plane passing through the centre of the tread and perpendicular to the axis of rotation. N is the number of periods P of the periodic curve, that is to say the number of times that the laying trajectory of the strip has to be repeated to form the crown bilayer. Therefore, the developed circumferential length of a crown layer is equal to N*(W/sin A), where W/sin A is the width of the strip projected on to the circumferential direction. The first relation N*(W/sin A)=2ΠR*t, where 0.6⇐t⇐1, reflects the fact that the developed circumferential length of a crown layer is less than or equal to the circumference 2ΠR of the cylindrical laying surface having a radius R, that is to say that the juxtaposition of strip portions is not usually carried out in a uniform manner, except for t=1. “Non-uniform juxtaposition of strip portions” is taken to mean a juxtaposition that may include a discontinuity or a gap between two adjacent strip portions. The coefficient t of the preceding relation is called the overlap rate, because it characterizes the greater or smaller number of gaps present in a crown layer.

Regarding the second relation, the total length of strip, projected on the circumferential direction, required to form the crown bilayer is equal to N*P, where N is the number of periods P of the periodic curve and where P is the period of the periodic curve. The second condition N*P=2ΠR*T expresses the fact that the total projected length of a strip is equal to a multiple T of the circumference 2ΠR of the cylindrical laying surface of radius R. T represents the number of winding turns of the strip on the cylindrical laying surface of radius R required to form the crown bilayer.

Finally, given that the trajectory of the circumferential zigzag winding generates strip crossovers between a radially outer portion of strip and a radially inner portion of strip, the inventors have classified these strip crossovers into outer crossovers and inner crossovers. By definition, a strip crossover is outer when the radially outer portion of strip forms a positive angle B with the circumferential direction in an axial plane. An axial plane is an oriented plane, defined by a first circumferential direction, tangential to the surface of revolution and oriented in the running direction of the tire, and a second axial direction, parallel to the axis of rotation of the tire: it is therefore a plane tangential to the surface of revolution. By definition also, a strip crossover is inner when the radially outer portion of strip forms a negative angle B with the circumferential direction in an axial plane.

The inventors aimed to obtain, in the vicinity of 40% of the strip crossovers positioned in a median zone of the axial width of the crown bilayer, that is to say outside the strip overlap zones present at the axial ends of the crown bilayer, a number of inner crossovers close to the number of outer crossovers, to obtain a uniformity of weave ensuring the uniform mechanical operation of the crown bilayer. This aim is achieved, according to the inventors, if, for at least 40% of the strip crossovers axially positioned, relative to the circumferential direction (XX′), at an axial distance L1 equal to not more than 0.25 times the amplitude L of the periodic curve, that is to say in the median zone, the circular bilayer portion centred on the strip crossover and having a radius equal to twice the width W of a strip, that is to say a limited radius, comprises Ne outer strip crossovers and Ni inner strip crossovers, such that |Ne-Ni|/(Ne+Ni)⇐0.3, thereby ensuring that the numbers of outer strip crossovers Ne and inner strip crossovers Ni, respectively, are similar.

Advantageously, any metal reinforcer having a circular cross section of diameter D, the width W of the strip is at least equal to D. The strip from which the crown bilayer is made up is at least formed by a single metal reinforcer coated in an elastomeric compound. The diameter D of the reinforcer is its overall diameter, not its compacted diameter.

Also advantageously, the width W of the strip is equal to not more than 0.2 times the amplitude L of the periodic curve. The strip from which the crown bilayer is formed must have a sufficient width; that is to say, it must be made up of a sufficient number of reinforcers to enable the crown bilayer to be formed sufficiently rapidly. However, this width must be limited to allow the winding of the strip without its twisting at the extrema of the periodic curve, that is to say at changes of direction of the trajectory. The phenomenon of twisting outside the plane of the strip is particularly troublesome with metal reinforcers.

Advantageously, the periodic curve having extrema and having a radius of curvature R′ at its extrema, the radius of curvature R′ of the periodic curve is at least equal to the amplitude L of the periodic curve. The radius of curvature of the periodic curve, which is minimal at its extrema, must have a minimum value to allow the winding of the strip with metal reinforcers without its twisting at the extrema, at which the trajectory of the strip changes direction.

Also advantageously, the periodic curve having extrema and having a radius of curvature R′ at its extrema, the radius of curvature R′ of the periodic curve is equal to not more than 7 times the amplitude L of the periodic curve. The radius of curvature of the periodic curve, which is minimal at its extrema, must still remain limited in order to obtain an angle A, with respect to the circumferential direction, that is not too small, being conventionally at least 15°, that is to say sufficient to obtain a transverse stiffness of the crown bilayer that enables correct transverse behaviour of the tire to be ensured.

Advantageously, the ratio T/N is at least equal to 0.15 and at most equal to 1.3. A circumferential zigzag winding defined by a number N of periods P distributed over a number T of circumferences 2ΠR*T, such that the ratio T/N lies within the preceding range, makes it possible to obtain the intended trajectory characteristics, as defined above, namely a sufficient angle A and minimum radii of curvature R′ at the extrema in the requisite ranges.

Preferably, N and T are whole numbers that are prime between each other. Because N and T are whole numbers that are prime between each other, it is possible to have a circumferential offset of the trajectory of the strip at each winding turn, so that there cannot be any radial superimposition of the trajectory of the strip.

According to a preferred embodiment, the metal reinforcers of the crown layers are elastic metal reinforcers having a structural elongation As at least equal to 0.5% and a tensile modulus of elasticity of not more than 150 GPa. The aforesaid characteristics are determined in an elastic metal reinforcer coated in a vulcanized elastomeric compound. The elastic behaviour of metal reinforcers as defined above, in particular with a structural elongation As of at least 0.5%, facilitates the performance of the level winding, that is to say the zigzag winding of the strip.

According to a variant of the preferred embodiment, the elastic metal reinforcers of the strip are multistrand ropes of structure 1×I comprising a single layer of I strands wound in a helix, each strand comprising an internal layer of J internal threads wound in a helix and an external layer of K external threads wound in a helix around the internal layer. Multistrand ropes are conventional embodiments of elastic metal reinforcers in the field of tires.

A crown reinforcement preferably comprises at least two crown bilayers. Being aware that a crown reinforcement of a tire for a civil engineering vehicle usually comprises six crown layers, divided into two protection layers, two working layers and two hooping layers, the inventors have conceived the replacement of the two working layers with a working bilayer, and/or of the two hooping layers with a hooping bilayer, and/or of the two protection layers with a protection bilayer. Thus different crown reinforcement configurations may be envisaged, such as a crown bilayer combined with four individual crown layers, two crown bilayers combined with two individual crown layers, or three crown bilayers. It should be noted that a simplified crown reinforcement, with only two crown bilayers, has also been envisaged by the inventors.

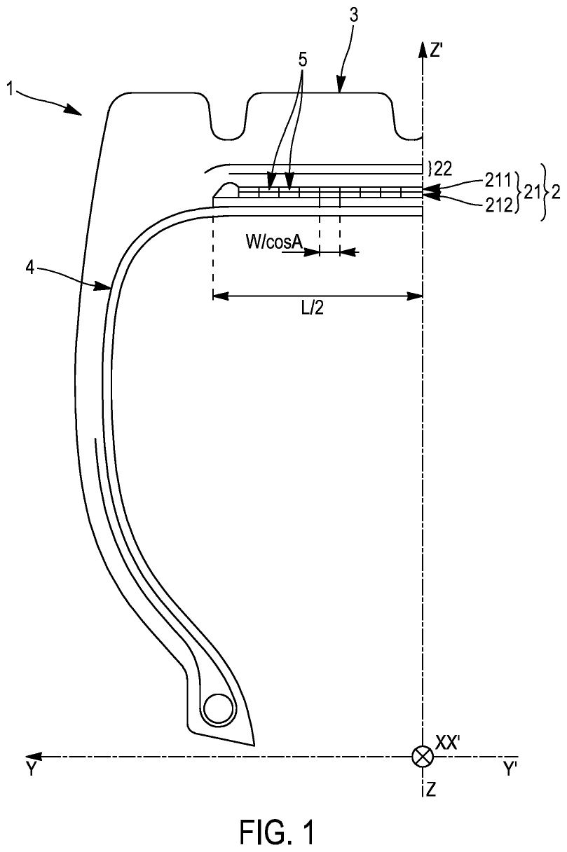

The features of the invention are illustrated by the schematic FIGS. 1 to 9, which are not drawn to scale:

FIG. 1: Meridian half-section of a crown of a tire for a civil engineering vehicle according to the invention.

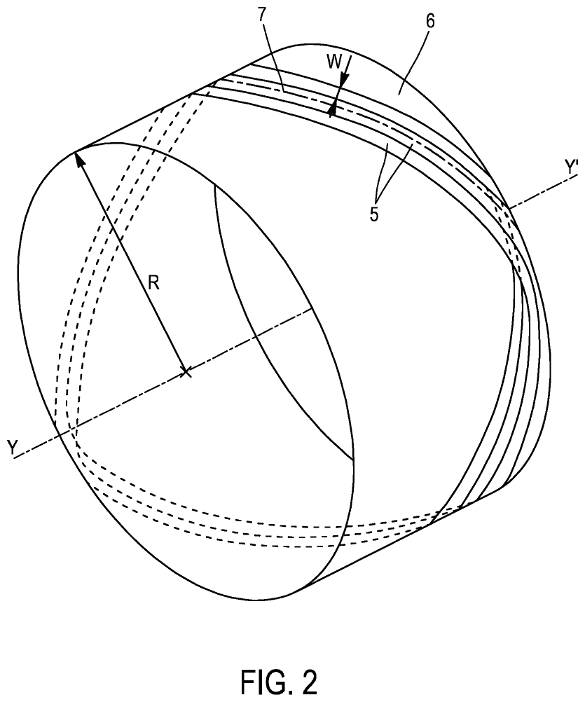

FIG. 2: Perspective view of a circumferential zigzag winding of a strip along a periodic curve on to a cylindrical laying surface.

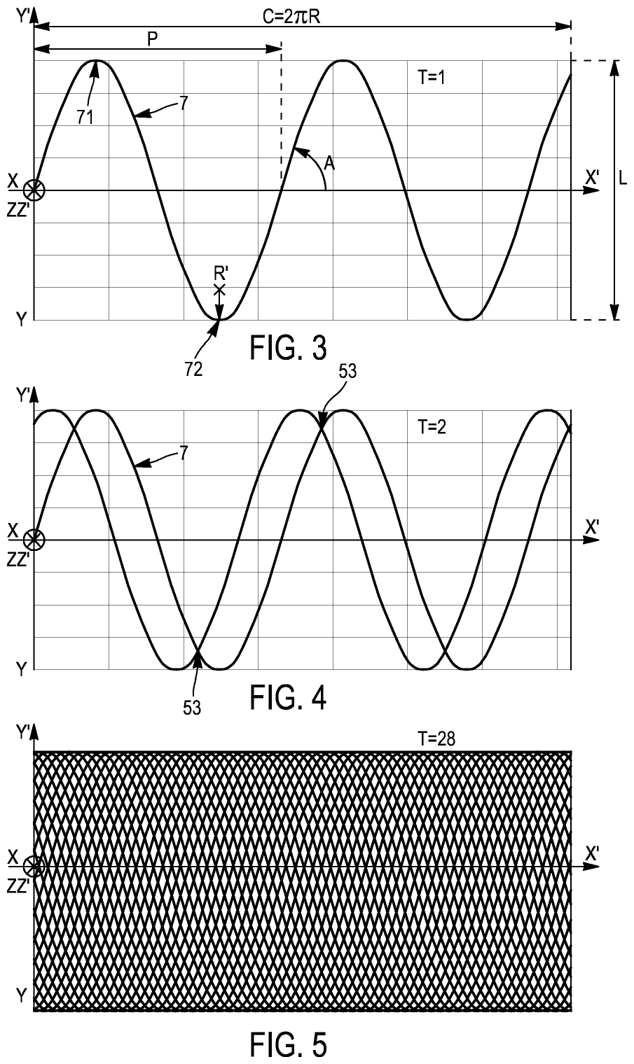

FIG. 3: Plan view of the trajectory of the strip at the end of T=1 one winding turn of the strip.

FIG. 4: Plan view of the trajectory of the strip at the end of T=2 winding turns of the strip.

FIG. 5: Plan view of the trajectory of the strip at the end of T=28 winding turns of the strip, corresponding to the crown bilayer in its final state.

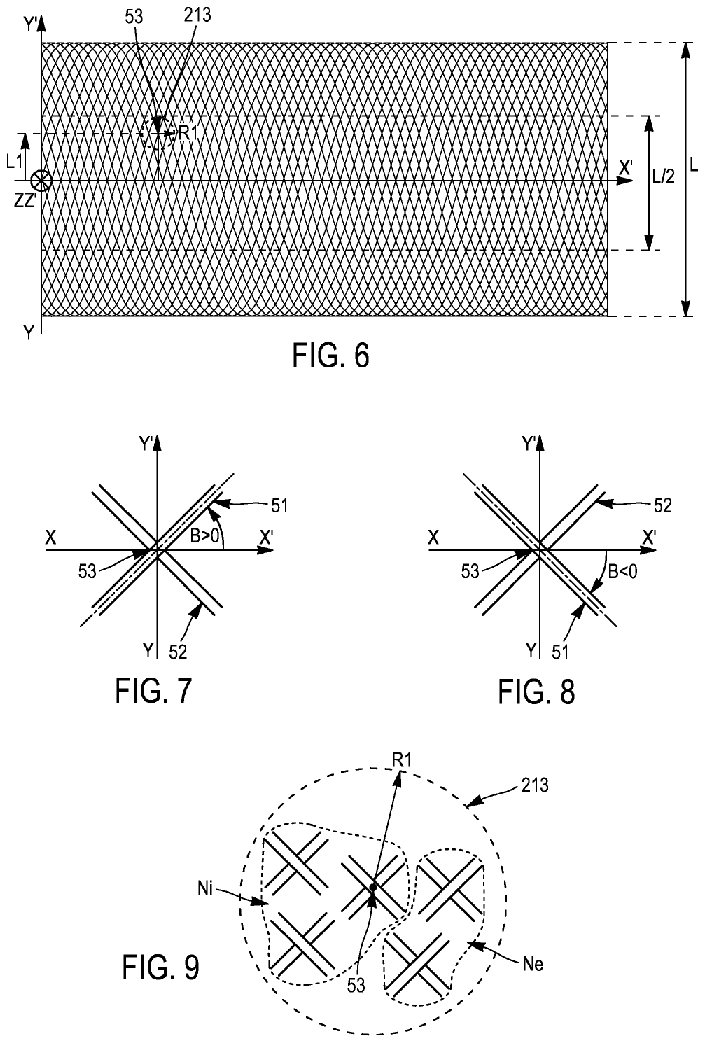

FIG. 6: Plan view of the trajectory of the strip at the end of T=28 winding turns of the strip with location of the strip crossovers in a median part.

FIG. 7: Diagram of an outer strip crossover.

FIG. 8: Diagram of an inner strip crossover.

FIG. 9: Principle of counting the inner and outer strip crossovers in the vicinity of a strip crossover.

FIG. 1 shows a meridian half-section, on a meridian plane YZ, passing through the axis of rotation YY′ of the tire, of a tire 1 for a civil engineering vehicle, comprising a crown reinforcement 2 radially on the inside of a tread 3 and radially on the outside of a carcass reinforcement 4. The crown reinforcement 2 comprises a crown bilayer 21 made up at least partially of two radially superposed crown layers (211, 212) and produced by the circumferential zigzag winding of a strip of width W onto a cylindrical laying surface of radius R (not shown), having as its axis of revolution the axis of rotation YY′ of the tire. In the embodiment shown, the crown bilayer 21 is a working bilayer, radially on the inside of a protective reinforcement 22 consisting of two protection layers. In the meridian plane YZ, each crown layer (211, 212) is made up of an axial juxtaposition of strip portions 5 of width W/cos A, where W is the width (not shown) of the strip 5, measured perpendicularly to the mid-line of the strip 5, and A is the angle (not shown) formed by the mid-line of the strip 5 with the circumferential direction XX′ in the equatorial plane XZ.

FIG. 2 is a perspective view of a circumferential zigzag winding of a strip 5 of width W, along a periodic curve 7, on to a cylindrical laying surface 6 which is a surface of revolution about the axis of rotation YY′ of the tire and has a radius R. This circumferential zigzag winding of a strip 5 forms a crown bilayer.

FIG. 3 is a plan view of the trajectory of the strip at the end of T=1 one winding turn of the strip, or, more precisely, of the middle fibre of the strip, the width of the strip not being shown, in order to improve the readability of the figure. This plan view, in a plane XY, corresponds to the developed surface of the cylindrical laying surface, having a length equal to the circumference C=2ΠR, where R is the radius of the cylindrical laying surface, and a width equal to the amplitude L of the periodic curve 7. The trajectory of the circumferential zigzag winding is a periodic curve 7 having a period P and an amplitude L. The periodic curve 7 forms, with the circumferential direction XX′, an angle A measured at the points on the curve positioned in an equatorial plane XZ passing through the centre of the tread and perpendicular to the axis of rotation YY′. The periodic curve 7 has extrema (71, 72) and has a radius of curvature R′ at its extrema (71, 72). In the embodiment shown, when the choices of the angle A and the radius of curvature R′ have been made, the period of the periodic curve 7 extends over 2.2 periods P, over one winding turn.

FIG. 4 is a plan view of the trajectory of the strip at the end of T=2 winding turns of the strip. In the embodiment shown, the periodic curve 7, in the second winding turn, crosses the trajectory of the 1^{st} winding turn at 5 points, thus creating 5 strip crossovers 53.

FIG. 5 is a plan view of the trajectory of the strip at the end of T=28 winding turns of the strip, corresponding to the crown bilayer in its final state. In the embodiment shown, the crown bilayer is in its final state when the curve 7 extends over a number N=61 of periods P distributed over a number T=28 of circumferences 2ΠR.

FIG. 6 is a plan view of the trajectory of the strip at the end of T=28 winding turns of the strip, corresponding to the crown bilayer in its final state, showing an example of a circular portion of bilayer 213, centred on a strip crossover 53, positioned at the axial distance L1, and having a radius R1 equal to twice the strip width W. This circular portion of bilayer 213 is a reference element on which are determined the number Ne of outer strip crossovers and the number Ni of inner strip crossovers in the vicinity of the strip crossover 53.

FIG. 7 is a diagram of an outer strip crossover 53 between a radially outer strip 51 and a radially inner strip 52. In the case of an outer strip crossover, the radially outer portion of strip 51 forms a positive angle B with the circumferential direction XX′ in an axial plane XY. An axial plane XY is an oriented plane, defined by a first circumferential direction XX′, tangential to the surface of revolution and oriented in the running direction of the tire, and a second axial direction YY′, parallel to the axis of rotation of the tire: it is therefore a plane tangential to the surface of revolution.

FIG. 8 is a diagram of an inner strip crossover 53 between a radially outer strip 51 and a radially inner strip 52. In the case of an inner strip crossover, the radially outer portion of strip 51 forms a negative angle B with the circumferential direction XX′ in an axial plane XY.

FIG. 9 shows schematically the principle of counting the inner and outer strip crossovers in the vicinity of a strip crossover, the latter being inner in the case shown. For each strip crossover 53 axially positioned, relative to the circumferential direction XX′, at an axial distance L1 equal to not more than 0.25 times the amplitude L of the periodic curve 7 (see FIG. 6), a circular bilayer portion 213, centred on the strip crossover 53 and having a radius equal to twice the width W of a strip 5, is defined. The respective numbers of outer strip crossovers Ne and inner strip crossovers Ni contained in said circular portion are then counted. It should be noted that the strip crossover 53, being inner in the case shown, is included in Ni. The parameters of the periodic zigzag winding are then optimized so that, for at least 40% of the selected strip crossovers, regardless of whether they are inner or outer, the following condition is satisfied: |Ne-Ni|/(Ne+Ni)⇐0.3. This condition ensures that the numbers of outer strip crossovers Ne and inner strip crossovers Ni, respectively, are similar, this criterion being, according to the inventors, characteristic of a uniform distribution of the inner and outer strip crossovers, resulting in uniform mechanical functioning of the crown bilayer.

The inventors have defined an optimized crown bilayer with level winding, as defined in the invention, for a tire for a civil engineering vehicle of the 24.00R35 size.

The tire under examination comprises a crown reinforcement made up of two crown bilayers, for which each of the crown layers is made up of elastic metal reinforcers of the multistrand rope type.

The structure of these multistrand ropes is of the 1×I type, comprising a single layer of I strands wound in a helix, each strand comprising an internal layer of J internal threads wound in a helix and an external layer of K external threads wound in a helix around the internal layer. In the example examined, the multistrand ropes used have a structure of 52.26=4*(5+8)*26; that is to say they are made up of I=4 strands, each strand comprising an internal layer of J=5 internal threads and an external layer of K=8 external threads wound in a helix around the internal layer, the threads having a cross section with a diameter d=0.26 mm. These reinforcers have a diameter D equal to 3.1 mm, a tensile elastic modulus E equal to 70 GPa, and a structural elongation As equal to 0.7%, and are distributed axially with an axial interval of 5 mm.

Table 1 below summarizes the properties of the multistrand elastic ropes tested:

TABLE 1

| Type of reinforcer | Rope 52.26 | |
|---|---|---|
| Diameter D of the reinforcer | 3.1 | mm |
| Number I of strands | 4 | |
| Number J of internal layer threads | 4 | |
| Number K of external layer threads | 9 | |
| Tensile modulus of elasticity | 70 | GPa |

| | |
|---|---|
| Structural elongation As | 0.7% |

The crown bilayer is made up of a circumferential zigzag winding of a strip of width W equal to 35 mm, in a circumferential direction XX′ of the tire and on a substantially cylindrical surface of revolution positioned at a radial distance R equal to 985 mm from the axis of rotation YY′ of the tire, this radial distance R being measured in an equatorial plane XZ passing through the middle of the tread and perpendicular to the axis of rotation YY′. The trajectory of the circumferential zigzag winding is a periodic curve having a period P equal to 2841 mm and an amplitude L equal to 400 mm. The periodic curve forms, with the circumferential direction XX′, an angle A equal to 24°, measured at the points on the curve positioned in the equatorial plane XZ. The periodic curve extends over a number N, equal to 61, of periods P distributed over a number T, equal to 28, of circumferences 2ΠR. The periodic curve of the trajectory of the circumferential zigzag winding satisfies the following relations: N*(W/sin A)=2ΠR*t=5.3 m where t=0.85, and N*P=2ΠR*T=173.3 m.

Table 2 below summarizes the properties of the periodic curve of the circumferential zigzag winding of the strip forming the crown bilayer:

TABLE 2

| Size | 24.00R35 | |
|---|---|---|
| Radius R of the cylindrical surface at the centre | 985 | mm |
| Width W of strip | 35 | mm |
| Angle at the centre A of the periodic curve | 24° | |
| Radius of curvature R′ at the extrema | 995 | mm |
| Period P of the periodic curve | 2841 | mm |
| Amplitude L of the periodic curve | 400 | mm |

| | |
|---|---|
| Number N of periods P | 61 |
| Number T of winding turns | 28 |
| Ratio T/N | 0.46 |
| Rate of overlap t of the level winding | 0.85 |

The inventors have found that, for 58% of the strip crossovers axially positioned, relative to the circumferential direction XX′, at an axial distance L1 equal to not more than 100 mm (=0.25*L), the circular bilayer portion centred on the strip crossover and having a radius R1 equal to 70 mm (=2*W) comprises Ne outer strip crossovers and Ni inner strip crossovers, such that |Ne-Ni|/(Ne+Ni)⇐0.3.

This invention, devised in the field of tires for civil engineering vehicles, may be applied to any tire comprising a crown reinforcement comprising at least two metallic crown layers, such as a tire for a heavy goods vehicle, for example.

1. A tire for a civil engineering vehicle, comprising:
a crown reinforcement radially on the inside of a tread and radially on the outside of a carcass reinforcement;
the crown reinforcement comprising at least a crown bilayer made up at least partially of two radially superimposed crown layers, each made up of reinforcers coated in an elastomeric material;
each crown bilayer being made up of a circumferential zigzag winding of a strip of width W, in a circumferential direction (XX′) of the tire and on a substantially cylindrical surface of revolution positioned at a radial distance R from the axis of rotation (YY′) of the tire; the trajectory of the circumferential zigzag winding being a periodic curve having a period P and an amplitude L;
the periodic curve forming, with the circumferential direction (XX′), an angle A measured at the points on the curve positioned in an equatorial plane (XZ) passing through the centre of the tread and perpendicular to the axis of rotation (YY′),
the periodic curve extending over a number N of periods P distributed over a number T of circumferences 2ΠR;
the trajectory of the circumferential zigzag winding generating strip crossovers between a radially outer portion of strip and a radially inner portion of strip;
a strip crossover being outer when the radially outer portion of strip forms a positive angle B with the circumferential direction (XX′) in an axial plane (XY);
a strip crossover being inner when the radially outer portion of strip forms a negative angle B with the circumferential direction (XX′) in an axial plane (XY);
wherein the crown layer reinforcers are made of metal, the periodic curve of the trajectory of the circumferential zigzag winding satisfies the following relations:
N*(W/sin A)=2ΠR*t, where 0.6⇐t⇐1,
N*P=2ΠR*T,
and for at least 40% of the strip crossovers axially positioned, relative to the circumferential direction (XX′), at an axial distance L1 equal to not more than 0.25 times the amplitude L of the periodic curve, the circular bilayer portion centred on the strip crossover and having a radius R1 equal to twice the width W of a strip comprises Ne outer strip crossovers and Ni inner strip crossovers, such that |Ne-Ni|/(Ne+Ni)⇐0.3.

2. The tire according to claim 1, wherein any metal reinforcer has a circular cross section of diameter D, and wherein the width W of the strip is at least equal to D.

3. The tire according to claim 1, wherein the width W of the strip is equal to not more than 0.2 times the amplitude L of the periodic curve.

4. The tire according to claim 1, wherein the periodic curve has extrema and a radius of curvature R′ at its extrema, and wherein the radius of curvature R′ of the periodic curve is at least equal to the amplitude L of the periodic curve.

5. The tire according to claim 1, wherein the periodic curve has extrema and has a radius of curvature R′ at its extrema, and wherein the radius of curvature R′ of the periodic curve is at least equal to 7 times the amplitude L of the periodic curve.

6. The tire according to claim 1, wherein the ratio T/N is at least equal to 0.15 and at most equal to 1.3.

7. The tire according to claim 1, wherein N and T are whole numbers that are prime between each other.

8. The tire according to claim 1, wherein the metal reinforcers of the crown layers are elastic metal reinforcers having a structural elongation As at least equal to 0.5% and a tensile modulus of elasticity of not more than 150 GPa.

9. The tire according to claim 8, wherein the elastic metal reinforcers of the strip are multistrand ropes of structure 1×I comprising a single layer of I strands wound in a helix, each strand comprising an internal layer of J internal threads wound in a helix and an external layer of K external threads wound in a helix around the internal layer.

10. The tire according to claim 1, wherein the crown reinforcement comprises at least two crown bilayers.
